(19) United States
(12) Patent Application Publication
(10) Pub. No.: US 2016/0225331 A1
(43) Pub. Date: Aug. 4, 2016

(54) DISPLAY DEVICE

(71) Applicant: Japan Display Inc., Minato-ku (JP)

(72) Inventors: Emi HIGANO, Tokyo (JP); Toshiyuki HIGANO, Tokyo (JP); Shigesumi ARAKI, Tokyo (JP)

(73) Assignee: Japan Display Inc., Minato-ku (JP)

(21) Appl. No.: 14/993,250

(22) Filed: Jan. 12, 2016

(30) Foreign Application Priority Data
Jan. 29, 2015 (JP) 2015-015015

(51) Int. Cl. G09G 3/36

(52) U.S. Cl. CPC G09G 3/3607; G09G 2300/0452; G09G 2320/0233; G09G 2320/0626; G09G 2330/023

(57) ABSTRACT

A display device includes: a first scanning line and a second scanning line which are provided along a first direction; a first signal line and a second signal line which are provided along a second direction; and a first subpixel and a second subpixel. Each of the first subpixel and the second subpixel is disposed between the first scanning line and the second scanning line and between the first signal line and the second signal line, and is provided with an electrode having a first main electrode portion and a first electrode portion connected with a first end of the first main electrode portion. The first electrode portion of the first subpixel and the first electrode portion of the second subpixel are provided at an interval along a direction free from being parallel to each of the first direction and the second direction.

### CLAIM OF PRIORITY

The present application claims priority from Japanese patent application JP2015-15015 filed on Jan. 29, 2015, the content of which is hereby incorporated by reference into this application.

### BACKGROUND

This disclosure relates to a display device, and is applicable, for example, to a display device of an RGBW method.

White display brightness of a liquid crystal display device is determined by brightness of a backlight and transmission of liquid crystal. Improving the brightness of backlight leads to an increase in power consumption. Thus, improving the transmission of liquid crystal is preferable. As a method for enhancing white brightness and then accomplishing a white peak display by practically improving transmission of liquid crystal, an example is set forth in Japanese Patent Application Laid-Open No. 2007-010753. This publication, without increasing power consumption, aims to accomplish improvement of transmission property by using white pixels as well, other than the original red, green and blue. That is, the display device includes a group of pixels having four subpixels, i.e., red, green, blue and white.

### SUMMARY

Having studied a display device of RGBW method in which, out of red subpixels, green subpixels and blue subpixels, half of the blue subpixels is replaced with white subpixels, the present inventors have found the following problem.

That is, in the liquid crystal mode of lateral electric-field type, for a strategy against a pressing-operation domain (a phenomenon in which, since a region having different arrays of liquid crystal molecules are mutually adjacent to each other, pressing, with a finger or the like, the screen of this crystal display device will unbalance an area ratio of the region in which directions of easily changing the array of the liquid crystal molecule are different, and then the pressed portion is colored depending on viewing angle), both tip ends of a comb tooth electrode is caused to bend. Compared with a normal portion, a bent portion becomes lower in transmission. Due to this, the bent portion is preferably disposed outside an effective pixel. In the case of a display device of RGBW method, however, the area between the red subpixel and the green subpixel is narrow. Due to this, it is necessary to take either of arranging the bent portion within the effective pixel or expanding the area between the red subpixel and the green subpixel, each of which may lower the transmission.

Other problems and new features will be evident from the description of this disclosure as well as enclosed drawings.

Briefing of the summary of typical one of this disclosures is as follows.

That is, a display device includes: a first scanning line and a second scanning line which are provided along a first direction; a first signal line and a second signal line which are provided along a second direction; and a first subpixel and a second subpixel each of which has a light-shielding portion and an opening portion. The first subpixel and the second subpixel are disposed along the second direction. The opening portion of each of the first subpixel and the second subpixel is disposed between the first scanning line and the second scanning line and between the first signal line and the second signal line. Each of the first subpixel and the second subpixel is provided with an electrode having a first main electrode portion and a first electrode portion connected with a first end of the first main electrode portion. The first electrode portion of the first subpixel and the first electrode portion of the second subpixel are provided at an interval along a direction free from being parallel to each of the first direction and the second direction.

### BRIEF DESCRIPTION OF THE DRAWINGS

FIG. 1 is a plan view for explaining about a display device of an RGBW method.

FIG. 2 is a cross sectional view for explaining about the display device of the RGBW method.

FIG. 3 is a plan view for explaining about the display device of the RGBW method.

FIG. 4 is a plan view for explaining about a display device according to an embodiment 1.

FIG. 5 is a plan view for explaining about the display device according to the embodiment 1.

FIG. 6 is a plan view for explaining about a display device according to a modified embodiment 1-1.

FIG. 7 is a plan view for explaining about a display device according to a modified embodiment 1-2.

FIG. 8 is a plan view for explaining about the display device according to the modified embodiment 1-2.

FIG. 9 is a plan view for explaining about a display device according to a modified embodiment 1-3.

FIG. 10 is a plan view for explaining about a display device according to a modified embodiment 1-4.

FIG. 11 is a plan view for explaining about the display device according to the modified embodiment 1-4.

FIG. 12 is a plan view for explaining about a display device according to an embodiment 2.

FIG. 13 is a plan view for explaining about a display device according to an embodiment 3.

FIG. 14 is a plan view for explaining about the display device according to the embodiment 3.

FIG. 15 is a plan view for explaining about a display device according to an example 3-1.

FIG. 16 is a cross sectional view for explaining about the display device according to the example 3-1.

FIG. 17 is a cross sectional view for explaining about the display device according to the example 3-1.

FIG. 18 is a plan view for explaining about a display device according to a modified embodiment 3-1.

FIG. 19 is a plan view for explaining about the display device according to the modified embodiment 3-1.

FIG. 20 is a plan view for explaining about a display device according to an example 3-2.

FIG. 21 is a plan view for explaining about a pressing operation domain strategy in a display device of an RGM method.

FIG. 22 is a plan view for explaining about the pressing operation domain strategy in the display device of the RGM method.

FIG. 23 is a plan view for explaining about the pressing operation domain strategy in the display device of the RGM method.

### DESCRIPTION OF THE PREFERRED EMBODIMENTS

Hereinafter, referring to drawings, explanations will be made about embodiments, modified embodiments and examples. However, disclosures are each merely an example. Therefore, disclosures whose proper changes can be easily imaged while keeping the gist of the present invention are, as a matter of course, included in the scope of the present invention. Further, for more clarifying explanations about the drawings, compared with an actual embodiment, the drawings shown herein are, as the case may be, denoted schematically in terms of width, thickness, configuration or the like of each part. However, such drawings are each merely an example, and therefore, do not limit the interpretation of the present invention. Further, in the description and each drawing, detailed explanations about elements same as those already-mentioned in terms of the already-described drawings, as the case may be, will be properly omitted by adding the same reference numerals or signs.

### <Pixel Array of RGBW Method>

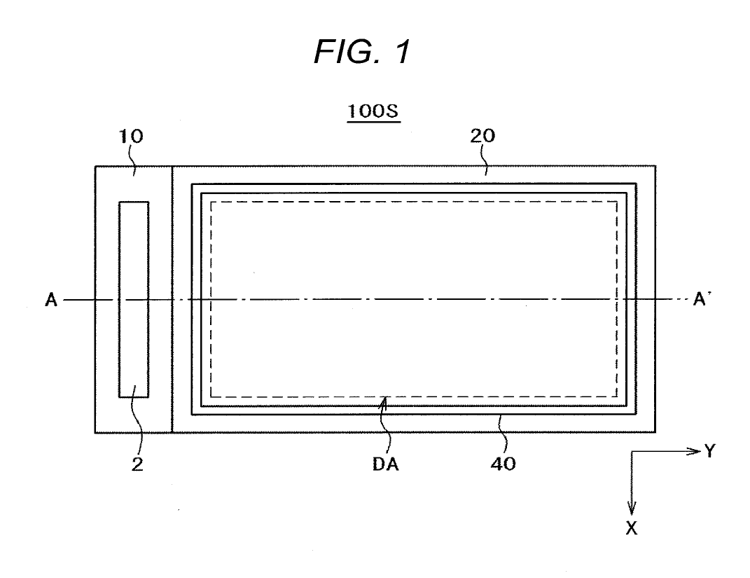

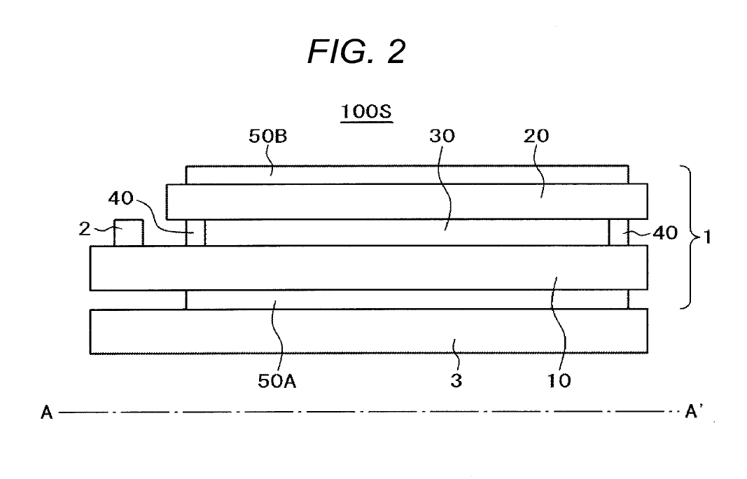

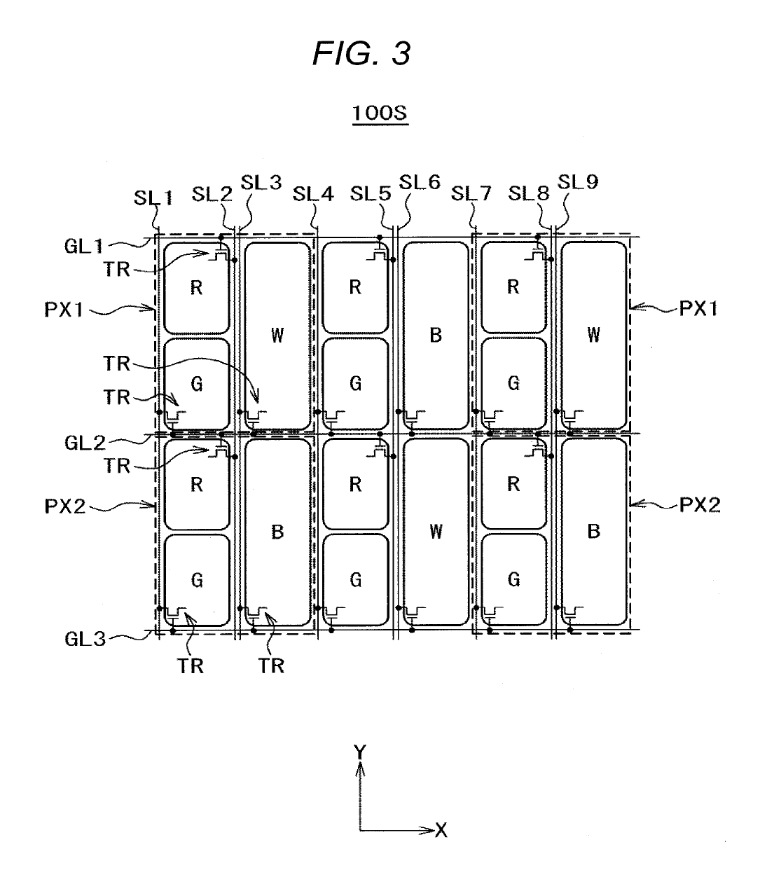

First, a display device of an RGBW method (hereinafter, simply referred to as “RGBW method”) will be explained about using FIG. 1 to FIG. 3. FIG. 1 is a plan view showing an entire schematic of a display device. FIG. 2 is a cross sectional view taken along the line A-A′ in FIG. 1. FIG. 3 is a plan view showing arrays of pixels, scanning lines and signal lines of the display device of an RGBW method.

As shown in FIG. 1 and FIG. 2, a display device 100S has a display panel 1, a driver IC 2 and a backlight 3. The display panel 1 has an array substrate 10, an opposing substrate 20, a liquid crystal material (liquid crystal layer) 30 sealed between the array substrate 10 and the opposing substrate 20. The array substrate 10 and the opposing substrate 20 are adhered with an annular seal material 40 surrounding a display area DA, and the liquid crystal layer 30 is sealed in a space surrounded by the array substrate 10, the opposing plate 20 and the seal material 40. Further, on the array substrate 10 and opposing plate 20's faces facing outward, that is, on rear faces of the array substrate 10 and opposing plate 20's faces opposing the liquid crystal layer 30, a lower polarizing plate 50A and an upper polarizing plate 50B are respectively provided.

Further, the display area DA is provided with a plurality of scanning lines each along one direction and a plurality of signal lines each along another direction. For example, the one direction is an extending direction of the display area DA, and the other direction is a short-side direction of the display area DA. The display area DA is, for example, surrounded by the scanning lines and signal lines, and has a structure of aggregate of a plurality of pixels disposed in a form of a matrix.

The array substrate 10 has a pixel transistor formed with a thin transistor (TFT), scanning lines, signal lines, pixel electrodes, a not-shown scanning circuit formed with a TFT and adapted to drive the scanning line, and others. The driver IC 2 has a circuit (not shown) for driving the signal line.

A pixel having a red color layer is referred to as a red subpixel (R), a pixel having a green color layer is referred to as a green subpixel (G), a pixel having a blue color layer is referred to as a blue subpixel (B), and a pixel having a white color layer is referred to as a white subpixel (W) Each subpixel has an opening portion and a light-shielding portion. That is, the light-shielding portion is disposed between opening portions of each subpixel, and the pixel transistor, the scanning line and the signal line are positioned in the light-shielding portion.

As shown in FIG. 3, the display device 100S of RGBW method has a first pixel PX1 having red, green and white subpixels, and a second pixel PX2 having red, green and blue subpixels. The blue subpixel and the white subpixel are the same in number. An opening area of each of the green and red subpixels is about ½ of an opening area of each of the blue and white subpixels. Regarding the first pixel PX1, in the direction Y, the red subpixel and the green subpixel are adjacently disposed, and, in the direction X, the red and green subpixels are disposed adjacent to the white subpixel. Regarding the second pixel PX2, in the direction Y, the red subpixel and the green subpixel are adjacently disposed, and, in the direction X, the red and green subpixels are disposed adjacent to the blue subpixel. In the direction X, the first pixel PX1 and the second pixel PX2 are alternately disposed in the direction X, and, in the direction Y, the first pixel PX1 and the second pixel PX2 are alternately disposed. Configuration of the opening of each of the red, green, blue and white is rectangular, and the length of the opening in the direction Y is longer than the length of the opening in the direction X. Further, despite a roundness of each of the four corners of the opening of one of the subpixels, the configuration of each opening is referred to as rectangle. Preferably, the direction X is orthogonal to the direction Y.

The red, green, blue and white subpixels are each have a pixel transistor TR connected to the scanning line (gate line) and signal line (source line). The scanning line is connected to the gate electrode of the pixel transistor TR, and the signal line is connected to the source electrode of the pixel transistor TR.

Scanning lines GL1 to GL3 are provided along the direction X. The red subpixel of the first pixel PX1 disposed between the scanning line GL1 and the scanning line GL2 is connected to the scanning line GL1, and the green and white subpixels of the same first pixel PX1 are connected to the scanning line GL2. Further, the red subpixel of the second pixel PX2 disposed between the scanning line GL2 and the scanning line GL3 is connected to the scanning line GL2, and the green and blue subpixels of the same second pixel PX2 are connected to the scanning line GL3. That is, the green subpixel and the red subpixel which are adjacent to each other in the direction Y are connected to the same scanning line, and the white subpixel and the blue subpixel which are adjacent to each other in the direction Y are connected to the different scanning lines.

Signal lines SL1 to SL9 are provided along the direction Y. Signal lines SL1, SL4 and SL7 are each connected to the green subpixel, signal lines SL2, SL5 and SL 8 are each connected to the red subpixels, and signal lines SL3, SL6 and SL9 are each connected to the white and blue subpixels. The red and green subpixels are disposed between the signal line SL1 and the signal line SL2, and the white and blue subpixels are disposed between the signal line SL3 and the signal line SL4. Further, no subpixel is disposed between the signal line SL2 and the signal line SL2. In the display device 100S, one signal line is disposed between pixels, and two signal lines are disposed between the opening portions of the subpixels.

Embodiments set forth hereinafter relate to the display device of the above RGBW method. Red, green, white and blue subpixels are respectively referred to as first, second third and fourth subpixels. However, such subpixels are not limited to their respective colors. The direction X and direction Y are respectively referred to as first direction and second direction. However, such directions are not limited to their respective directions.

### Embodiment 1

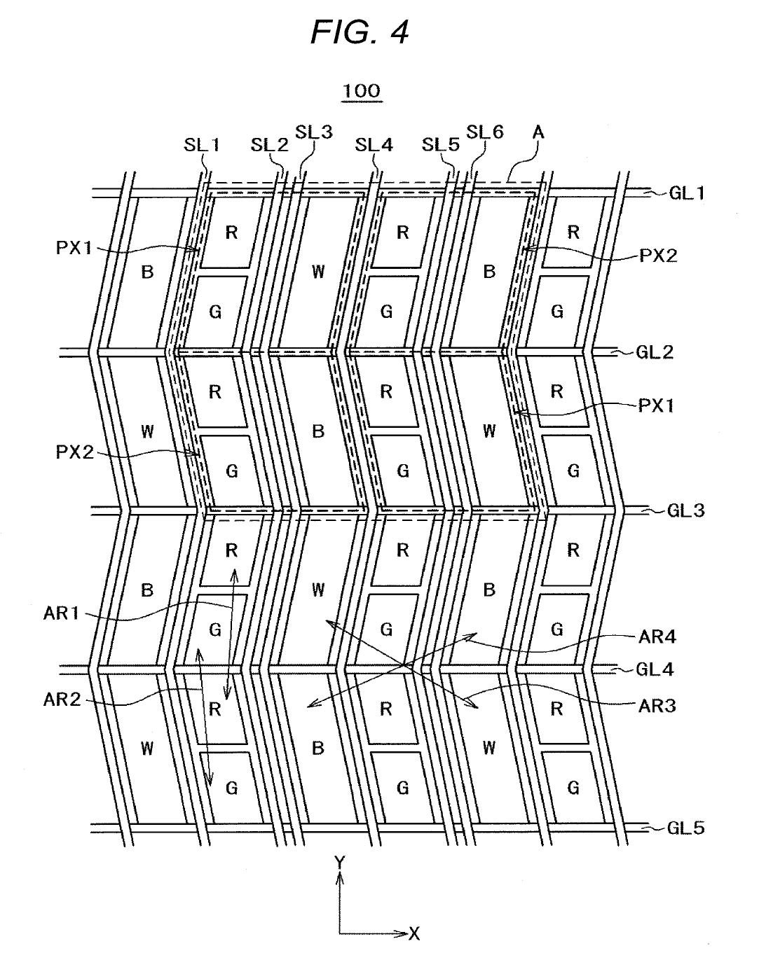

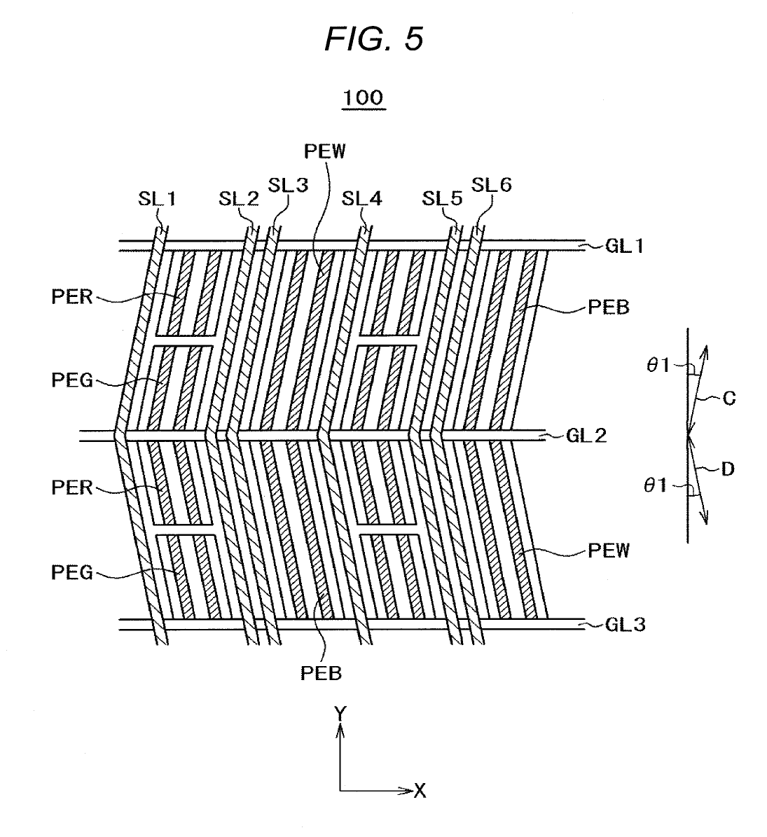

Using FIG. 4 and FIG. 5, an explanation will be made about a display device according to an embodiment 1. FIG. 4 is a plan view showing an pixel array of the display device according to the embodiment 1. FIG. 5 is a plan view showing the scanning lines, signal lines and pixel electrodes in FIG. 4.

As shown in FIG. 4, regarding a display device 100, arrangement of the pixels, scanning lines and signal lines, and their connections are basically the same as those of the display device 100S. Regarding the first pixel PX1, in the direction Y, the red subpixel and the green subpixel are adjacently disposed, and, in the direction X, the red and green subpixels are disposed adjacent to the white subpixel. Regarding the second pixel PX2, in the direction Y, the red subpixel and the green subpixel are adjacently disposed, and, in the direction X, the red and green subpixels are disposed adjacent to the blue subpixel. In the direction X, the first pixel PX1 and the second pixel PX2 are alternately disposed, and, in the direction Y, the first pixel PX1 and the second pixel PX2 are alternately disposed. Regarding the display device 100, pixels of a portion A in FIG. 4 are repeatedly disposed in the direction X and direction Y. This works to equidistantly dispose each of the red, green, blue and white subpixels along the direction X. This also works to equidistantly dispose each of the red, green, blue and white subpixels along the direction Y.

Configuration of the opening of each subpixel of the first, second pixels PX1, PX2 each disposed between the scanning line GL1 and the scanning line GL2 and between the scanning line GL3 and the scanning line GL4 is a parallelogram inclined in the clockwise direction, in plan view, relative to the direction Y. Configuration of the opening of each subpixel of the first, second pixels PX1, PX2 each disposed between the scanning line GL2 and the scanning line GL3 and between the scanning line GL4 and the scanning line GL5 is a parallelogram inclined in the counterclockwise direction, in plan view, relative to the direction Y. Regarding each of the red, green, blue and white subpixels, the length along the signal line is longer than the length in the direction X. Further, despite a roundness (not shown) of each of four corners of the opening of one of the respective subpixels, configuration of the opening is referred to as parallelogram.

As shown in FIG. 5, a direction C (third direction) along which the signal lines SL1 to SL6 disposed between the scanning line GL1 and the scanning line GL2 extend is inclined by θ1 in the clockwise direction, in plan view, relative to the direction Y. A direction D (fourth direction) along which the signal lines SL1 to SL6 disposed between the scanning line GL2 and the scanning line GL3 extend is inclined by θ1 in the counterclockwise direction, in plan view, relative to the direction Y. Herein, θ1 is an angle larger than 0 degree and smaller than 45 degrees. Preferably, θ1 is, for example, an angle from 5 degrees to 15 degrees. As set forth above, the scanning line extends along one direction, however, may be bent when viewed per pixel unit.

A pixel electrode PER of the red subpixel, a pixel electrode PEG of the green subpixel, a pixel electrode PEW of the white subpixel and a pixel electrode PEB of the blue subpixel have each two electrodes, and an extending direction of the two electrodes is parallel to the direction in which the signal lines extend. In other words, an extending direction of an opening portion having a slit or the like between the two electrode is parallel to the direction in which the signal lines extend. The extending direction of the opening portion having a slit or the like between two electrodes is inclined relative to the direction Y by a predetermined angle. The extending direction of each of the electrode and the opening portion which are disposed between the scanning line GL1 and the scanning line GL2 is parallel to the direction C. The extending direction of each of the electrode and the opening portion which are disposed between the scanning line GL2 and the scanning line GL3 is parallel to the direction D.

Further, forming the two comb-teeth configuration by each of the pixel electrodes PER, PEG, PEW and PEB according to this embodiment is one example, and otherwise the configuration may be one strip or one flat plate.

By this, in the pixels (subpixels) disposed between the scanning line GL1 and the scanning line GL2 and between the scanning line GL2 and the scanning line GL3, two areas are formed in which the horizontal rotational directions of liquid crystal molecules are different from each other. That is, regarding the red subpixels, two pixels denoted by an arrow mark AR1 and disposed in the direction Y are made into a pair, to thereby form a pseudo dual domain (2-pixel pseudo dual domain). Regarding the green subpixels, two pixels denoted by an arrow mark AR2 and disposed in the direction Y are made into a pair, to thereby form a pseudo dual domain. Regarding the white subpixels, two diagonally-facing pixels denoted by an arrow mark AR3 are made into a pair, to thereby form a pseudo dual domain. Regarding the blue subpixels, two diagonally-facing pixels denoted by an arrow mark AR4 are made into a pair, to thereby form a pseudo dual domain. This carries out a viewing angle compensation.

### Modified Embodiment 1-1

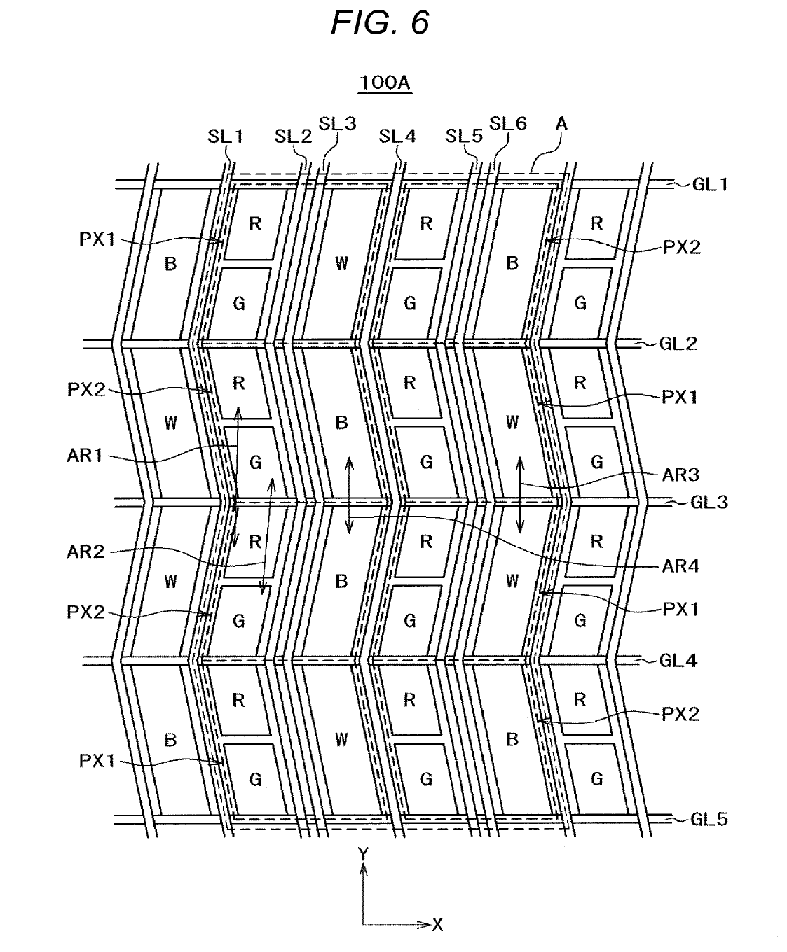

Using FIG. 6, an explanation will be made about a display device according to a first modified embodiment of the embodiment 1. FIG. 6 is a plan view showing a pixel array of the display device according to the modified embodiment 1-1.

A display device 100A according to the modified embodiment 1-1 is basically the same as the display device 100, but disposition of each of the first pixel and the second pixel is different. In the portion A in FIG. 6, on the left side of the area between the scanning line GL1 and the scanning line GL2, the first pixel PX1 is disposed, and, on the right side of the same area, the second pixel PX2 is disposed. On the left side of the area between the scanning line GL2 and the scanning line GL3, the second pixel PX 2 is disposed, and, on the right side of the same area, the first pixel PX1 is disposed. On the left side of the area between the scanning line GL3 and the scanning line GL4, the second pixel PX 2 is disposed, and, on the right side of the same area, the first pixel PX1 is disposed. On the left side of the area between the scanning line GL4 and the scanning line GL5, the first pixel PX1 is disposed, and, on the right side of the same area, the second pixel PX2 is disposed. Regarding the display device 100A, pixels in the portion A in FIG. 6 are repeatedly disposed in the direction X and direction Y. Inclinations of the signal lines and pixel electrodes of the display device 100A are the same as those of the display device 100. This works to equidistantly dispose each of the red, green, blue and white subpixels along the direction X. This also works to equidistantly dispose each of the red, green, blue and white subpixels along the direction Y.

As shown in FIG. 6, regarding the red subpixel, two pixels denoted by the arrow mark AR1 and disposed in the direction Y are made into a pair, thus forming a pseudo dual domain. Regarding the green subpixel, two pixels denoted by the arrow mark AR2 and disposed in the direction Y are made into a pair, thus forming a pseudo dual domain. Regarding the white subpixel, two pixels denoted by the arrow mark AR3 and disposed in the direction Y are made into a pair, thus forming a pseudo dual domain. Regarding the white subpixel, two pixels denoted by the arrow mark AR4 and disposed in the direction Y are made into a pair, thus forming a pseudo dual domain. This carries out a viewing angle compensation. Regarding the display device 100A, than in the case of the display device 100, the pair of subpixels forming the pseudo dual domain of the white subpixels are positioned closer to each other, and the pair of subpixels forming the pseudo dual domain of the blue subpixels are positioned closer to each other, thus making it possible to further improve the viewing angle.

### Modified Embodiment 1-2

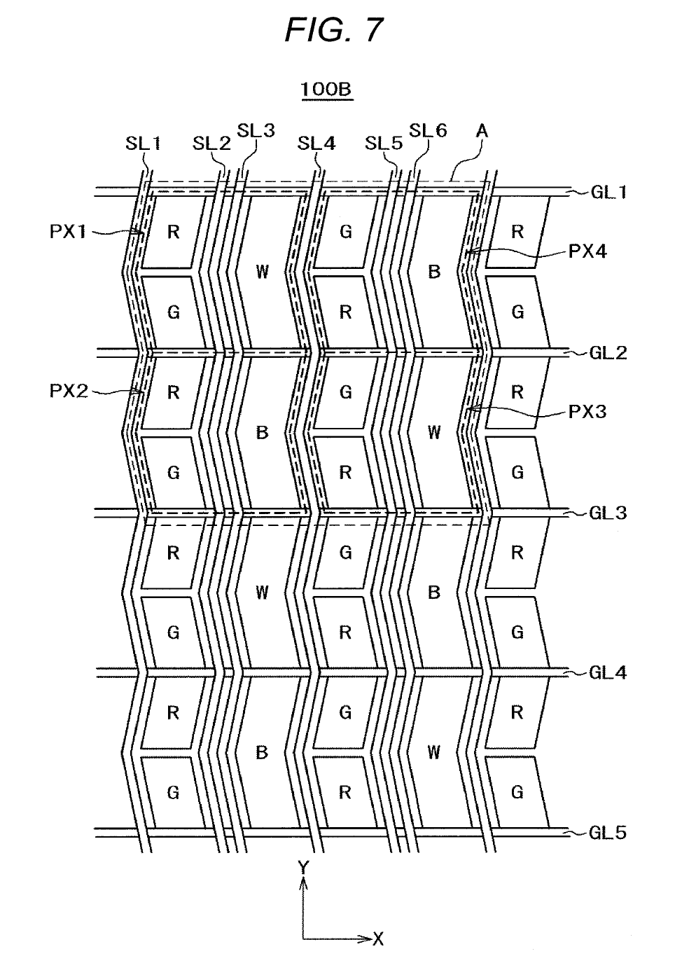

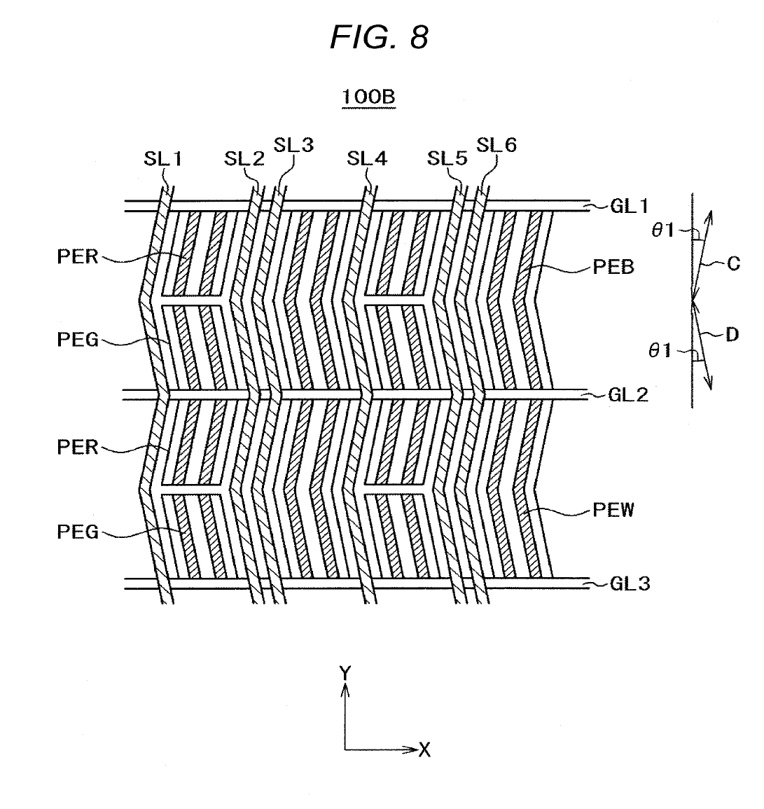

Using FIG. 7 and FIG. 8, an explanation will be made about a display device according to a second modified embodiment of the embodiment 1. FIG. 7 is a plan view showing a pixel array of the display device according to the modified embodiment 1-2. FIG. 8 is a plan view showing the scanning lines, signal lines and pixel electrodes, of the portion A in FIG. 7.

Regarding a display device 100B according to the embodiment 1-2, other than the first pixel PX1 and second pixel PX2, there are provided a third pixel PX3 including a red subpixel, a green subpixel and a white subpixel, and a fourth pixel PX4 including a red subpixel, a green subpixel and a blue subpixel. Regarding the third pixel PX3, in the direction Y, the red subpixel and the green subpixel are adjacently disposed, and, in the direction X, the red and green subpixels are disposed adjacent to the white subpixel, like in the case of the first pixel PX1, but disposition of each of the red subpixel and the green subpixel in the direction Y is opposite to the disposition in the case of the first pixel PX1. Regarding the fourth pixel PX4, in the direction Y, the red subpixel and the green subpixel are adjacently disposed, and, in the direction X, the red and green subpixels are disposed adjacent to the blue subpixel, like in the case of the second pixel PX2, but disposition of each of the red subpixel and the green subpixel in the direction Y is opposite to the disposition in the case of the second pixel PX2. In the portion A in FIG. 7, between the scanning line GL1 and the scanning line GL2 and between the scanning line GL3 and the scanning line GL4, the first pixel PX1 and the fourth pixel PX4 are disposed, and between the scanning line GL2 and the scanning line GL3 and between the scanning line GL4 and the scanning line GL5, the second pixel PX2 and the third pixel PX3 are disposed. In the display device 100B, pixels of the portion A in FIG. 7 are repeatedly disposed in the direction X and direction Y.

As shown in FIG. 7, configuration of the opening of the red subpixel of each of the first, second pixels PX1, PX2 is a parallelogram inclined in the clockwise direction, in plan view, relative to the direction Y, and configuration of the opening of the green subpixel of each of the first, second pixels PX1, PX2 is a parallelogram inclined in the counterclockwise direction, in plan view, relative to the direction Y. Configuration of the opening of the green subpixel of each of the third pixel PX3, PX4 is a parallelogram inclined in the clockwise direction, in plan view, relative to the direction Y, and configuration of the opening of the red subpixel of each of the third pixel PX3, PX4 is a parallelogram inclined in the counterclockwise direction, in plan view, relative to the direction Y. Configuration of the opening of each of the white and blue subpixels is bent. Configuration of the opening of the white subpixel of each of the first, second pixels PX1, PX2 is a combination of an upper side which is a parallelogram inclined in the clockwise direction, in plan view, relative to the direction Y and a lower side which is a parallelogram inclined in the counterclockwise direction, in plan view, relative to the direction Y. Configuration of the opening of the blue subpixel of each of the second, fourth pixel PX2, PX4 is a combination of an upper side which is a parallelogram inclined in the clockwise direction, in plan view, relative to the direction Y and a lower side which is a parallelogram inclined in the counterclockwise direction, in plan view, relative to the direction Y. Further, despite a roundness (not shown) of each of four corners of the opening of one of the respective subpixels, configuration of the opening is referred to as parallelogram.

As shown in FIG. 8, signal lines SL1 to SL6 are disposed in a manner to be bent per pixel. The signal lines SL1 to SL6 each are partially bent in a first position in the vicinity of an intermediate portion of adjacent scanning lines and in a second position in which the scanning line is disposed, and the entirety of signal lines is provided along the direction Y. The direction in which the signal lines SL1 to SL6 are extending includes a portion parallel to the direction C and a portion parallel to the direction D. Between the two scanning lines GL1 and GL2, the signal line, in plan view, shows a line-symmetry relation with respect to the direction X.

The pixel electrode PER, pixel electrode PEG, pixel electrode PEW and pixel electrode PEB each have two electrodes, and the two electrodes are disposed in the direction in which the signal lines extend. In other words, an extending direction of an opening portion having a slit or the like between the two electrodes is disposed parallel to the direction in which the signal lines extend. The extending direction of the opening portion having a slit or the like between the two electrodes is inclined relative to the direction Y by a predetermined angle. Each of the electrode and the opening portion of one of the pixel electrode PER and the pixel electrode PEG is linear, and each of the electrode and the opening portion of one of the pixel electrode PEW and the pixel electrode PEB is bent.

The extending direction of each of the electrode and the opening portion of the red subpixel of the first pixel PX1 and the green subpixel of the fourth pixel PX4 which are disposed between the scanning line GL1 and the scanning line GL2 is parallel to the direction C. The extending direction of each of the electrode and the opening portion of the green subpixel of the first pixel PX1 and the red subpixel of the fourth pixel PX4 is parallel to the direction D. The extending direction of each of the electrode and the opening portion of the white subpixel of the first pixel PX1 and the blue subpixel of the fourth pixel PX4 has a portion parallel to the direction C and a portion parallel to the direction D. The extending direction of each of the electrode and the opening portion of the blue subpixel of the second pixel PX2 and the white subpixel of the third pixel PX3 which are disposed between the scanning line GL2 and the scanning line GL3 has a portion parallel to the direction C and a portion parallel to the direction D.

Regarding each of the red and green subpixels, two adjacent pixels inclined opposite to each other are made into a pair, thus forming a pseudo duel domain. Regarding each of the white and blue subpixels, a duel domain is formed within one subpixel.

### Modified Embodiment 1-3

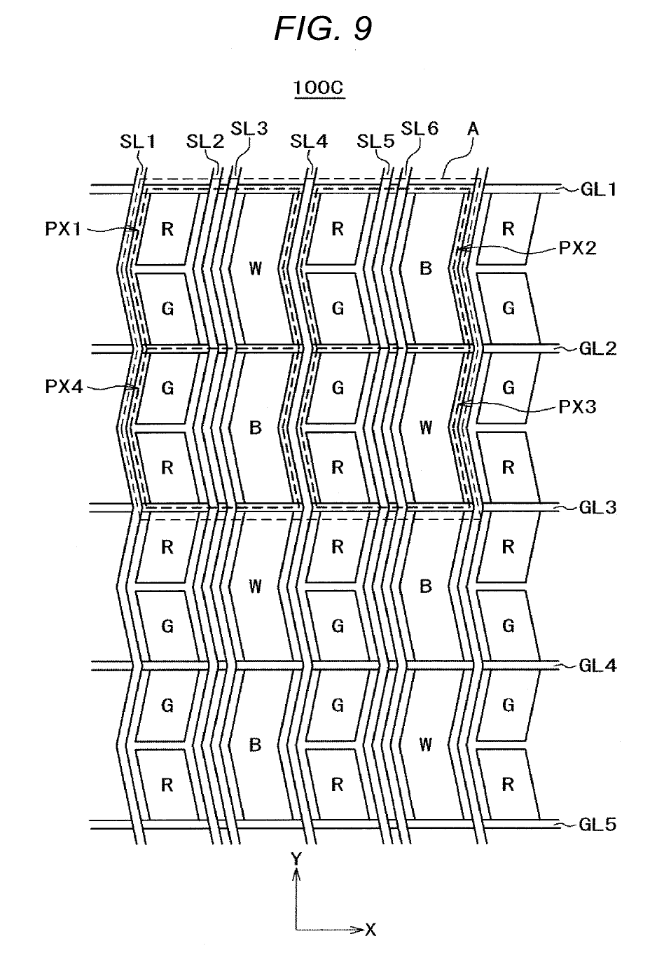

Using FIG. 9, an explanation will be made about a display device according to a third modified embodiment of the embodiment 1. FIG. 9 is a plan view showing a pixel array of the display device according to the modified embodiment 1-3.

Configuration of the signal line and the first, second, third, fourth pixels PX1, PX2, PX3, PX4 of a display device 100C according to the modified embodiment 1-3 are the same as those of the display device 100B, but arrangement of the first, second, third, fourth pixels PX1, PX2, PX3, PX4 is different. Regarding the display device 100C, the pixels in the portion A in FIG. 9 are repeatedly disposed in the direction X and direction Y. This works to equidistantly dispose each of the red, green, blue and white subpixels along the direction X. This also works to equidistantly dispose, along the direction Y, the red subpixels of the first pixel PX1 and the green subpixels of the fourth pixels PX4.

As shown in FIG. 9, regarding each of the red and green subpixels, two adjacent pixels inclined opposite to each other are made into a pair, thus forming a pseudo dual domain. Regarding each of the white and blue subpixels, a dual domain is formed within one subpixel.

### Modified Embodiment 1-4

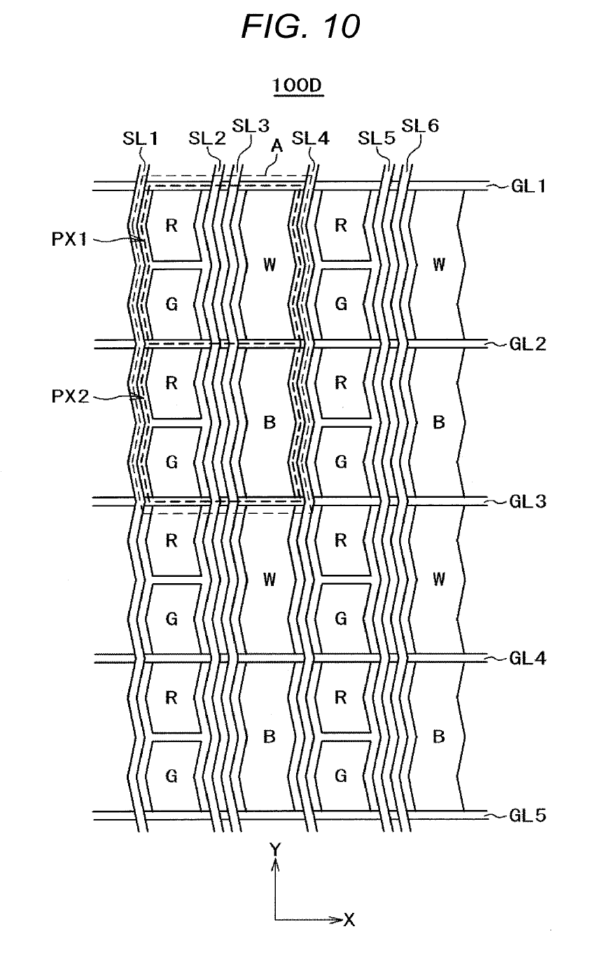

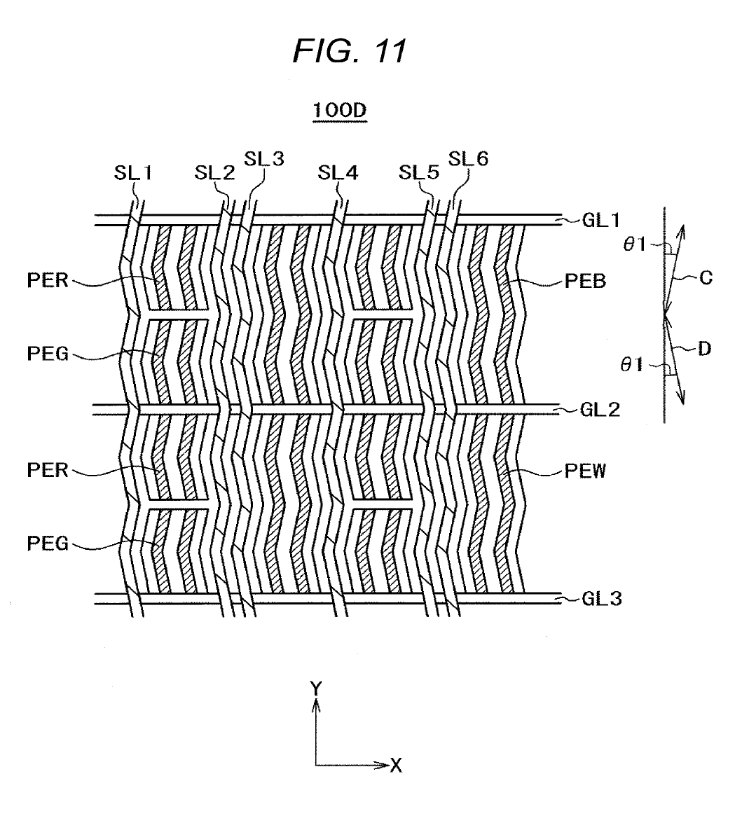

Using FIG. 10 and FIG. 11, an explanation will be made about a display device according to a fourth modified embodiment of the embodiment 1. FIG. 10 is a plan view showing a pixel array of the display device according to the modified embodiment 1-4. FIG. 11 is a plan view showing the scanning lines, signal lines and pixel electrodes of the display device according to the modified embodiment 1-4.

Arrangement of the pixels, scanning lines and signal lines of a display device 100D according to the modified embodiment 1-4 are basically the same as those of the display device 100. The first pixel PX1 or the second pixel PX2 is continuously disposed in the direction X, and the first pixel PX1 and the second pixel PX2 are alternately disposed in the direction Y. Regarding the display device 100D, the pixels of the portion A in FIG. 10 are repeatedly disposed in the direction X and direction Y.

As shown in FIG. 10, configuration of the opening of each of the red and green subpixels of the first, second pixels PX1, PX2 is a combination of an upper side which is a parallelogram inclined rightward and a lower side which is a parallelogram inclined leftward. Configuration of the opening of each of the white subpixel of the first pixel PX1 and the blue subpixel of the second pixel PX2 is a combination of four parallelograms including parallelograms inclined rightward and parallelograms inclined leftward. Further, despite a roundness (not shown) of each of four corners of the opening of one of the respective subpixels, configuration of the opening is referred to as parallelogram.

As shown in FIG. 11, the signal lines SL1 to SL6 each are disposed in a manner to be bent per subpixel. The signal lines SL1 to SL6 each are bent in a first position in the vicinity of an intermediate portion of adjacent scanning lines, a second position in the vicinity of an intermediate portion between the first portion and the scanning line, and a third position in which the scanning line is disposed. The direction in which the signal lines SL1 to SL 6 extends has a portion parallel to the direction C and a portion parallel to the direction D. Between the two scanning lines GL1 and GL2, the signal line, in plan view, shows a line-symmetry relation with respect to the direction X.

The pixel electrode PER, pixel electrode PEG, pixel electrode PEW and pixel electrode PEB each have two electrodes, and the two electrodes are disposed in the direction in which the signal lines extend. In other words, an extending direction of the opening portion having a slit or the like between the two electrodes is disposed parallel to the direction in which the signal lines extend. The extending direction of the opening portion having a slit or the like between the two electrodes is inclined relative to the direction Y by a predetermined angle. The electrode and the opening portion of each of the pixel electrode PER and the pixel electrode PEG are each bent once, and the electrode and the opening portion of each of the pixel electrode PEW and the pixel electrode PEB are each bent three times. The pixel electrode of each of the subpixels of one of the respective first pixel PX1 and second pixel PX2 has a portion parallel to the direction C and a portion parallel to the direction D.

As shown in FIG. 10 and FIG. 11, each of the subpixels of the first, second pixels PX1, PX2 forms a dual domain within one subpixel.

### Embodiment 2

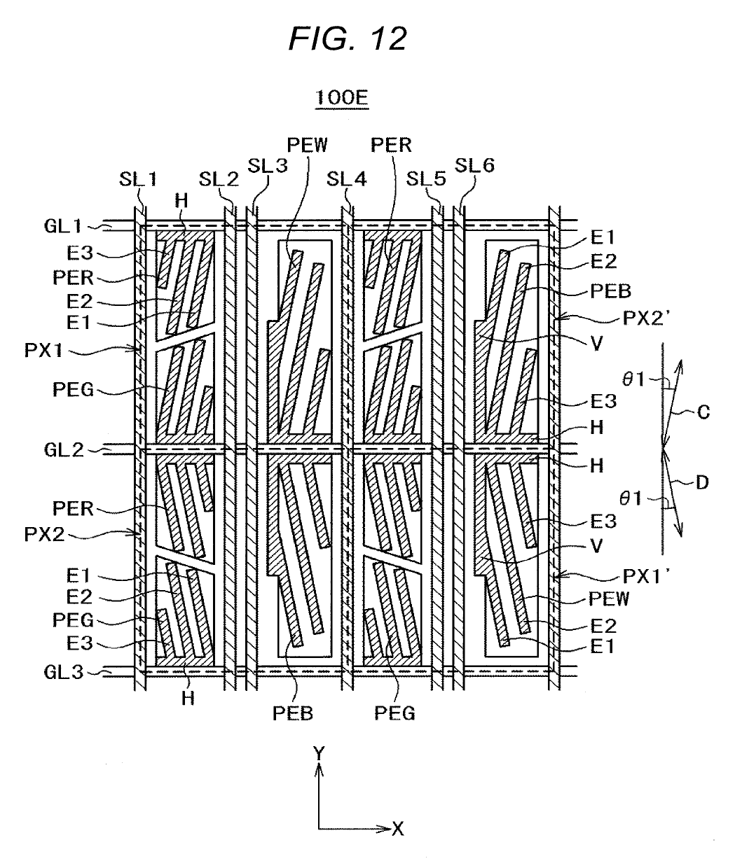

Using FIG. 12, an explanation will be made about a display device according to an embodiment 2. FIG. 12 is a plan view showing the pixel array, scanning lines, signal lines and pixel electrodes according to the embodiment 2.

Regarding a display device 100E according to the embodiment 2, configuration of the pixel, configuration of the pixel electrode and configuration of the signal line are different from those of the display device 100, but others are the same as those of the display device 100.

Regarding the display device 100E, arrangement of the pixels, scanning lines and signal lines, and their connections are basically the same as those of the display device 100S. Regarding first pixels PX1, PX1′, in the direction Y, the red subpixel and the green subpixel are adjacently disposed, and, in the direction X, the red and green subpixels are disposed adjacent to the white subpixel. Regarding second pixels PX2, PX2′, in the direction Y, the red subpixel and the green subpixel are adjacently disposed, and, in the direction X, the red and green subpixels are disposed adjacent to the blue subpixel. In the direction X, the first pixel PX1 and the second pixel PX2′, or the second pixel PX2 and the first pixel PX1′ are alternately disposed. In the direction Y, the first pixel PX1 and the second pixel PX2, or the second pixel PX2′ and the first pixel PX1′ are alternately disposed. Regarding the display device 100E, the pixels in FIG. 12 are repeatedly disposed in the direction X and direction Y.

Configuration of the opening of each of the red and green subpixels is a trapezium having two parallel sides in the direction Y, and configuration of the opening of each of the white and green subpixels is a rectangle elongated in the direction Y. The scanning lines GL1, GL2, GL3 are provided along the direction X. Signal lines SL1 to SL6 are provided along the direction Y. Further, despite a roundness of each of the four corners of the opening of one of the subpixels, the configuration of each opening is referred to as trapezium or rectangle.

An explanation will be made about a pixel electrode of this embodiment.

The pixel electrode PEW of the first pixel PX1 and the pixel electrode PEB of the second pixel PX2′ each have a first electrode H in a form of a strip provided along the direction X, a second electrode V provided along the direction Y, and first, second, third electrodes E1, E2, E3 each in a form of a strip provided along a direction forming an angle θ1, relative to the direction Y, in the clockwise direction in plan view. The first, second, third electrodes E1, E2, E3 are disposed in such a manner as to define a predetermined distance. One end of the first electrode E1 is connected with the second electrode V. One end of each of the second, third electrodes E2, E3 is connected with the first electrode H.

Further, the first, second, third electrodes E1, E2, E3 each in a form of a strip are not limited to three in number. It is preferable that, at least one of the first, second, third electrodes E1, E2, E3 is connected with the first electrode H in a form of a strip, and at least one of the other first, second, third electrodes E1, E2, E3 is connected with the second electrode V in a form of a strip. By this, the pixel electrode is disposed in a wide range within the pixel. Further, an electrode connected with another end of one of the first, second, third electrodes E1, E2, E3 each in a form of a strip may be disposed. Regarding the pixel electrode, not limited to three including E1, E2, E3 per subpixel, two or more is allowed.

The pixel electrode PEB of the second pixel PX2 and pixel electrode PEW of the first pixel PX1′ each have a first electrode H in a form of a strip provided along the direction X, a second electrode V in a form of a strip provided along the direction Y, and first, second, third electrodes E1, E2, E3 each in a form of a strip provided along a direction forming an angle θ1, relative to the direction Y, in the counterclockwise direction in plan view. The first, second, third electrodes E1, E2, E3 are disposed in such a manner as to define a predetermined distance. One end of the first electrode E1 is connected with the second electrode V. One end of each of the second, third electrodes E2, E3 is connected with the first electrode H. Further, it is preferable that the first electrode H and the second electrode V are each in a form of one strip per subpixel. Further, another end of the first electrode E1 is so disposed as to define a distance relative to the first electrode H. Another end of the electrode E3 is so disposed as to define a distance relative to the second electrode V.

The pixel electrodes PEG, PER, of the first pixel PX1, each include a first electrode H provided along the direction X, and first, second, third electrodes E1, E2, E3 each provided along a direction forming an angle θ1, relative to the direction Y, in the clockwise direction in plan view.

Regarding the pixel electrodes PEG, PER of the second pixel PX2, the first, second, third electrodes E1, E2, E3 each are provided along a direction forming an angle θ1, relative to the direction Y, in the counterclockwise direction in plan view.

It is preferable that, in plan view, another end of each of the first, second, third electrodes E1, E2, E3 is disposed within the opening portion of each subpixel. It is preferable that the first, second electrodes H, V each, in plan view, overlap with the light-shielding portion and are provided in the light-shielding portion. It is preferable that the length of the second electrode V is more than or equal to one third to less than or equal to two thirds of the length, in the direction Y, of the opening portion. By this, the pixel electrode E1 can, in plan view, overlap with the opening portion, and the second electrode V has a length not to hinder other portions. Configuration of each of the first, second, third electrodes E1, E2, E3 is not limited to linear, but may be bent or curved.

By this, regarding the red and green subpixels, the two pixels adjacent to each other in the direction Y are made into a pair, to thereby form a pseudo duel domain, and, regarding the white and blue subpixels, the two adjacent pixels are made into a pair, to thereby form a pseudo duel domain. Linearizing the signal line and inclining the pixel electrode can, without the need for bending the pixel electrode, inhibit any light leak of the bent portion. Thus, the viewing angle in the right and left directions can be enlarged, and any contrast decrease can be inhibited.

The second electrode V is disposed adjacent to the signal lines SL3, SL6. That is, the second electrode V is disposed on a side for arranging the two signal lines adjacently, defining a great distance relative to the adjacent subpixel, thus making it possible to inhibit occurrence, of any leak electric field, to the adjacent subpixel.

### Embodiment 3

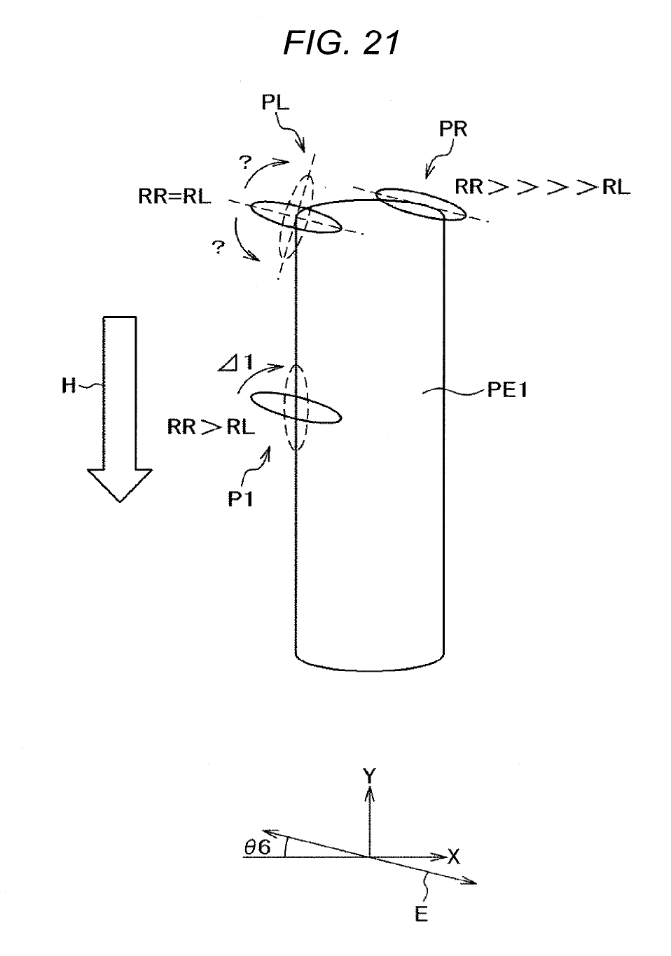

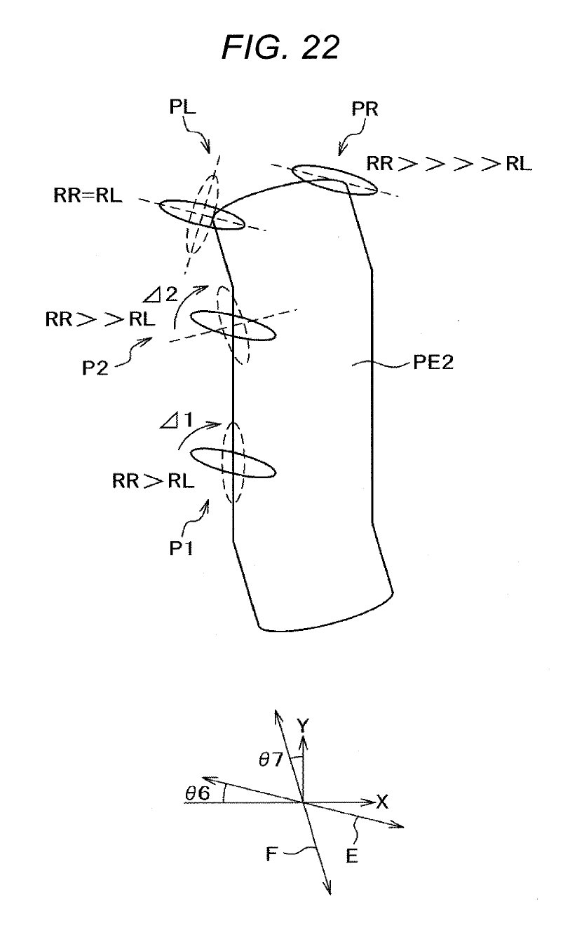

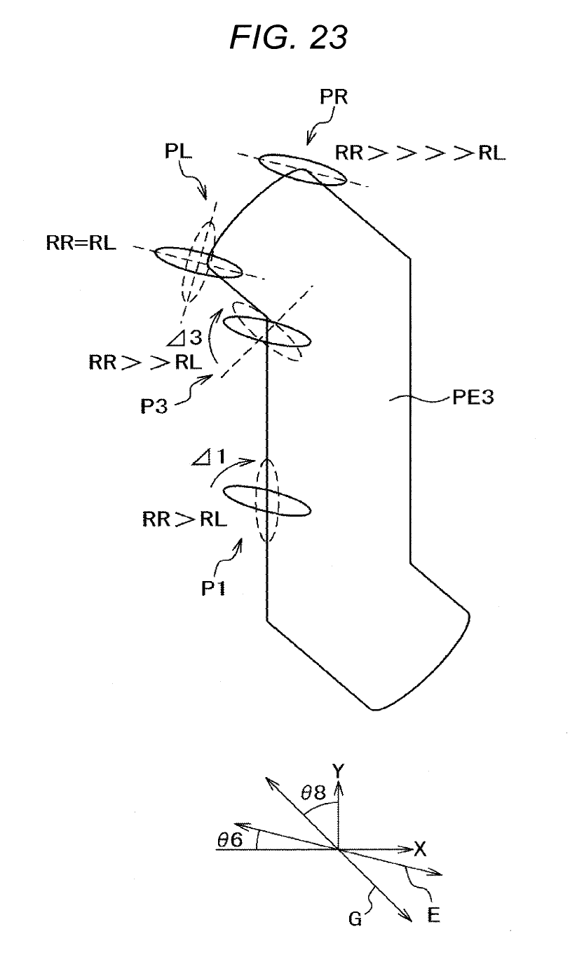

First, using FIG. 21 to FIG. 23, an explanation will be made about the pressing operation domain strategy in the display device of an RGB method. FIG. 21 shows an orientation of a liquid crystal molecule of a negative liquid crystal in the case that the tip end of the pixel electrode is not bent. FIG. 22 shows an orientation of the liquid crystal molecule of the negative liquid crystal in the case that the tip end of the pixel electrode is slightly bent. FIG. 23 shows an orientation of the liquid crystal molecule of the negative liquid crystal in the case that the tip end of the pixel electrode is significantly bent.

Using FIG. 21 to FIG. 23, an explanation will be made about the reason why both tip ends of the comb tooth electrode are bent. The ellipse of the solid line shows an initial orientation of the liquid crystal molecule, and the ellipse of the broken line shows an orientation of the liquid crystal molecule after voltage application. The liquid crystal molecule, at the time of the initial orientation, points to the direction E, causing an inclination of θ6 in the clockwise direction relative to a direction −X. In this way, the liquid crystal molecule is provided along the direction different from either the direction X or the direction Y, that is, a direction neither parallel nor vertical to the direction along which the pixel electrode extends. In this way, when a voltage is applied to the pixel electrode, the liquid crystal molecule is made easier to rotate, compared with a case in which the liquid crystal molecule is disposed in the direction parallel to or vertical to the direction along which the pixel electrode extends.

In the case that a voltage is applied to the pixel electrode, a force making a clockwise rotation in plan view is defined as RR, and a force making a counterclockwise direction in plan view is defined as RL. Namely, when the RR is greater than the RL, the liquid crystal molecule makes a clockwise rotation, and when the RL is greater than the RR, the liquid crystal makes a counterclockwise rotation.

As shown in FIG. 21, in a linear portion P1 in the vicinity of the center in the direction Y in a pixel electrode PE1, the RR is greater than the RL, causing the liquid crystal molecule after voltage application to make the clockwise rotation. This free energy is defined as Δ1. Further, in the right upper end portion PR of the pixel electrode PE1, the RR becomes much larger than the RL, bringing the liquid crystal molecule after voltage application into a state of easily making a clockwise direction.

On the other hand, in the left upper end portion PL of the pixel electrode PE1, the RR and the RL become substantially equal to each other, causing a portion in which whether the liquid crystal molecule after voltage application makes a clockwise rotation or a counterclockwise rotation is not determined. Herein, it is known that, when the liquid crystal molecule is subjected to a pressing operation, the boundary featuring RL=RR moves in the direction denoted by an arrow mark H. In the case of a line, an area in which whether the clockwise rotation or the counterclockwise rotation is not determined is likely to expand, causing a harmful effect on the display.

As shown in FIG. 22, a bent portion P2 of a pixel electrode PE2 extends toward a direction F, causing an inclination leftward by θ7 relative to the direction Y. In the linear portion P1, in the direction Y, of the pixel electrode PE2, like in the case of FIG. 21, the energy RR in the clockwise direction is larger than the energy RL in the counterclockwise direction, causing the liquid crystal molecule after voltage application to make a clockwise rotation. Further, like the pixel electrode in FIG. 21, in the left upper end portion PL of the pixel electrode PE2, RR=RL, failing to determine whether the liquid crystal molecule after voltage application makes a clockwise rotation or a counterclockwise rotation.

However, in the bent portion P2 of the pixel electrode PE2, the RR is larger than the RL, thus causing the liquid crystal molecule after voltage application to make a clockwise rotation. With this free energy defined as Δ2, Δ1>Δ2.

Compared with the configuration of the pixel electrode in FIG. 21, the pixel electrode in FIG. 22 causes a greater difference, at the boundary of the P2, between the RR and the RL. Thus, the area failing to determine whether the clockwise rotation or the counterclockwise rotation is narrower, compared with that in FIG. 22.

As shown in FIG. 23, a pixel electrode PE3 extends toward the direction G from a bent portion P3, causing an inclination leftward by θ8 relative to the direction Y. Herein, θ8>θ7. Further, Δ2>Δ3. Namely, when the angle of the bent portion is enlarged, the difference, between the RR and the RL, at the bent portion becomes larger. Thus, enlarging the angle of the bent portion of the pixel electrode narrows the area failing to determine whether the clockwise rotation or the counterclockwise rotation, thus making it possible, even when the pressing operation is implemented, to extensively keep the area for allowing the liquid crystal molecule to make a proper rotation.

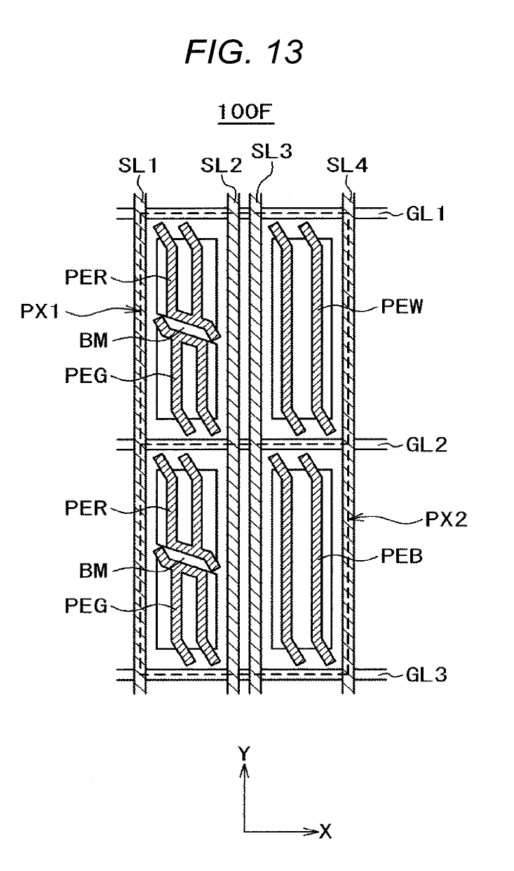

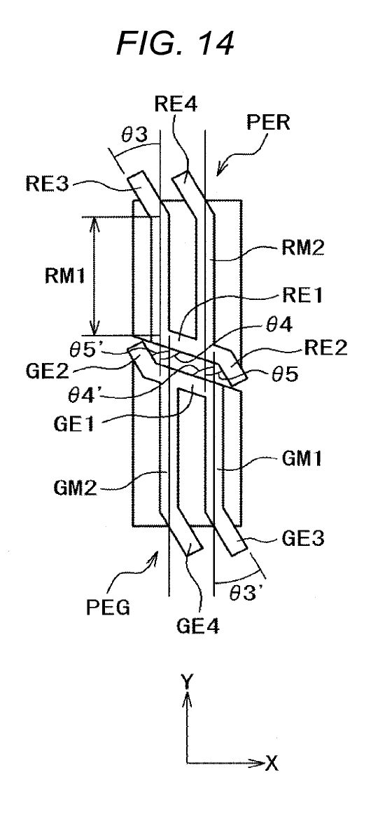

Using FIG. 13 and FIG. 14, an explanation will be made about a display device according to the embodiment 3. FIG. 13 is a plan view showing patterns of the pixel array and pixel electrode of the display device according to the embodiment 3. FIG. 14 is a plan view showing, in detail, the pattern of the pixel electrode of the display device according to the embodiment 3.

Regarding a display device 100F according to the embodiment 3, arrangement of the pixels, scanning lines and signal lines, and their connections are basically the same as those of the display device 100S. Regarding the first pixel PX1, in the direction Y, the red subpixel and the green subpixel are adjacently disposed, and, in the direction X, the red and green subpixels are disposed adjacent to the white subpixel. Regarding the second pixel PX2, in the direction Y, the red subpixel and the green subpixel are adjacently disposed, and, in the direction X, the red and green subpixels are disposed adjacent to the blue subpixel. In the direction X, the first pixel PX1 and the second pixel PX2 are alternately disposed, and, in the direction Y, the first pixel PX1 and the second pixel PX2 are alternately disposed. Regarding the display device 100F, the pixels in FIG. 13 are repeatedly disposed in the direction X and direction Y.

As shown in FIG. 13, configuration of the opening of each of the red and green subpixels is a trapezium having two parallel sides in the direction Y, with the short side in the direction Y longer than the length in the direction X. Configuration of the opening of each of the white and blue subpixels is a rectangle which is long in the direction Y. Further, despite its roundness (not shown) of each of the four corners of the opening of one of the respective subpixels, the configuration of the opening is referred to as trapezium or rectangle. The scanning lines GL1, GL2, GL3 are provided along the direction X. The signal lines SL1 to SL6 are provided along the direction Y.

As shown in FIG. 14, the pixel electrode PER of the red subpixel includes main electrode portions RM1, RM2 and first to fourth electrode portions RE1, RE2, RE3, RE4. The main electrode portion RM1 and the main electrode portion RM2 are connected with the first electrode portion RE1. The main electrode portions RM1, RM2 are provided along the direction Y. The third, fourth electrode portions RE3, RE4 are, in plan view, bent in the counterclockwise direction by θ3 relative to the direction Y. θ3 is set in a range of 5° to 45°, and more preferably 25° to 40°. The first electrode portion RE1 is bent, in plan view, in the counterclockwise direction by θ4 relative to the direction −Y. θ4 is larger than θ3, set in a range of 20° to 75°, and more preferably, 45° to 75°. The second electrode portion RE2 is bent, in plan view, in the counterclockwise direction by θ5 relative to the direction −Y. θ5 is larger than θ3, and smaller than θ4. When the liquid crystal molecule is along the direction X, θ5<θ4 rather enlarges the angle formed by the liquid crystal molecule and the pixel electrode, thus causing the liquid crystal molecule to rotate easily.

Further, for elongating the main electrode portion RM1, θ3<θ4 is preferable.

The pixel electrode PER of the red subpixel according to this embodiment includes the main electrode portion RM1 and the first electrode portion RE1 and the third electrode portion RE3 each connected with one of both ends of the main electrode RM1. Further, the pixel electrode PER of the red subpixel according to this embodiment includes the main electrode portion RM2 and the second electrode portion RE2 and the fourth electrode portion RE4 each connected with one of both ends of the main electrode RM2.

In this way, bending both ends of the linear portion of the pixel electrode can reduce a harmful effect, on the display, attributable to the above pressing operation.

Further, the first electrode portion RE1 is connected with the second electrode portion RE2.

The pixel electrode PEG of the green subpixel includes main electrode portions GM1, GM2 and first to fourth electrode portions GE1, GE2, GE3, GE4. The main electrode portions GM1 and the main electrode portion GM2 each are connected with the first electrode portion GE1. The first electrode portion GE1 and the first electrode portion RE1 are disposed by defining an interval therebetween, and are preferably parallel to each other in plan view. The main electrode portions GM1, GM2 are provided along the direction Y. The third, fourth electrode portions GE3, GE4 are, in plan view, bent by θ3′ in the counterclockwise direction relative to the direction −Y. θ3′ is set in a range of 5° to 45°. The first electrode portion GE1 is, in plan view, bent by θ4′ in the counterclockwise direction relative to the direction Y. θ4′ is larger than θ3′ and is set in a range of 20° to 75°. The second electrode portion GE2 is, in plan view, bent by θ5′ in the counterclockwise direction relative to the direction Y. θ5′ is larger than θ3′ and is smaller than θ4′. It is preferable that θ3 is equal to θ3′, θ4 is equal to θ4′ and θ5 is equal to θ5′. In this case, the light-shielding portion between the opening portion of the red subpixel and the opening portion of the green subpixel is so disposed as to be inclined by θ4 relative to the direction Y (90°−θ4 relative to the direction X). The area between the red subpixel and the green subpixel is so structured as to be divided in a direction not parallel to the direction in which the scanning line extends. Due to this, arranging the comb tooth electrode by activating the effective pixel to the maximum extent possible can suppress reduction of transmission.

Further, the main electrodes of the white and blue pixel electrodes PEW, PEB are, in plan view, parallel to the red and green main electrode portions RM1, RM2, GM1, GM2. Further, the electrodes on both ends of the white and blue pixel electrodes PEW, PEB are, in plan view, parallel to the red and green electrode portions RE3, RE4, GE3, GE4.

### Example 3-1

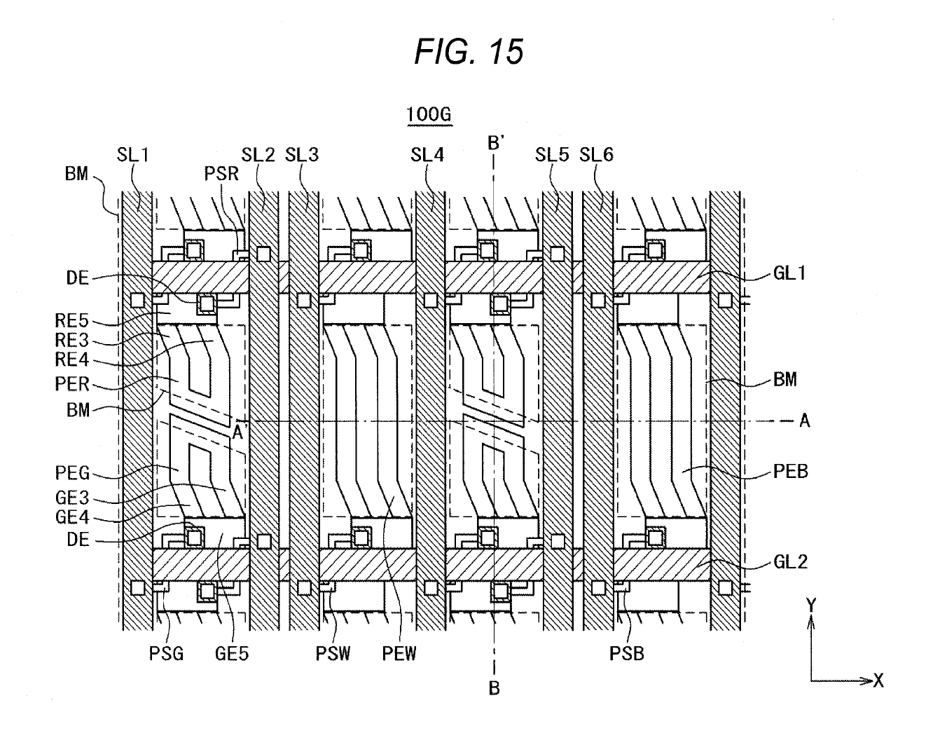

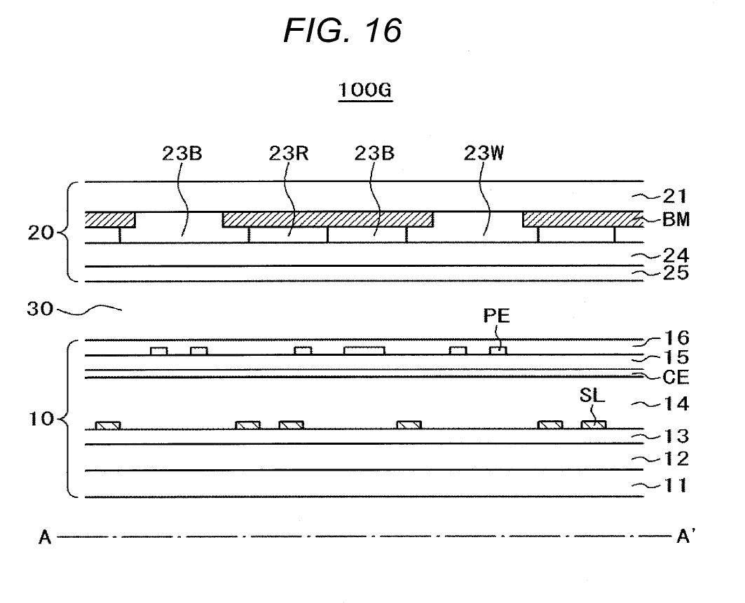

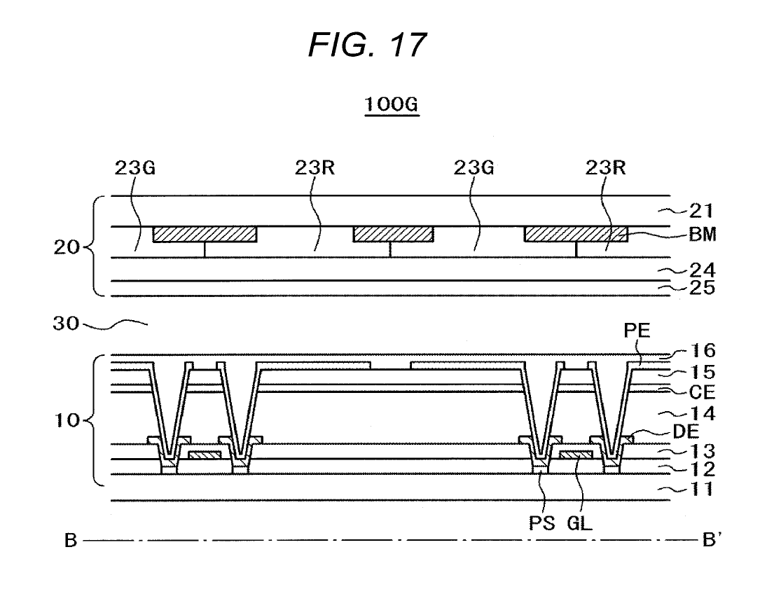

Using FIG. 15 to FIG. 17, an explanation will be made about a display device according to a first example of the embodiment 3. FIG. 15 is a plan view showing patterns of the scanning line, signal line, pixel electrode and light-shielding portion of the display device according to the example 3-1. FIG. 16 is a cross sectional view taken along the line A-A′. FIG. 17 is a cross sectional view taken along the line B-B′.

Regarding a display device 100G according to the example 3-1, arrangement of the pixels, scanning lines and signal lines, and their connections are basically the same as those of the display device 100S.

The array substrate 10 has the following structure. A semiconductor layer PS is formed on a glass substrate 11. Though not shown in FIG. 17, a scanning line GL is formed, via a gate insulating membrane 12, above the semiconductor layer PS. Preferably, the semiconductor layer PS is made from polysilicon, but may be made of another semiconductor. Above the gate insulating membrane 12 and the scanning line GL, the signal line SL and a drain electrode DE are formed via the interlayer insulating membrane 13. Via a contact hole opened in the gate insulating membrane 12 and interlayer insulating membrane 13, the signal line SL is connected with one end of the semiconductor layer PS. Via the contact hole opened in the gate insulating membrane 12 and interlayer insulating membrane 13, the drain electrode DE is connected with another end of the semiconductor layer PS. Via an organic insulating layer (flattened membrane) 14, a common electrode CE is formed above the interlayer insulating membrane 13, signal line SL and drain electrode DE. Via an interlayer insulating membrane 15, the pixel electrode PE is formed above the common electrode CE. Via a contact hole opened in the membrane 14 and interlayer insulating membrane 15, the pixel electrode PE is connected with the drain electrode DE. An orientation membrane 16 is formed above the interlayer insulating membrane 15 and on the pixel electrode PE.

The opposing substrate 20 includes a glass substrate 21, a light-shielding portion BM formed beneath the glass substrate 21, a color filter 23 formed beneath the glass substrate 21 and light-shielding portion BM, an overcoat membrane (flattened membrane) 24 formed beneath the color filter 23, and an orientation membrane 25 formed beneath the membrane 24.

As shown in FIG. 15, a connecting portion RE5 for connecting the electrode portion RE3 of the pixel electrode PER with the electrode portion RE4 of the pixel electrode PER is connected with a semiconductor layer PSR via the drain electrode DE. The signal line SL2 is connected with the semiconductor layer PSR. The semiconductor layer PSR runs across an area below the scanning line GL1. The connecting portion GE5 connecting the connecting portion GE3 with the electrode portion GE4 is connected with the semiconductor layer PSG via the drain electrode DE. The signal line SL2 is connected with the semiconductor layer PSG. The semiconductor layer PSG runs across an area below the scanning line GL2. In plan view, the portion where the pixel electrode PER opposes the pixel electrode PEG is covered with the light-shielding portion BM. The scanning lines GL1, GL2, the connecting portions RE5, GE5, and the signal lines SL1 to SL6 are also covered with the light-shielding portion BM.

### Modified Embodiment 3-1

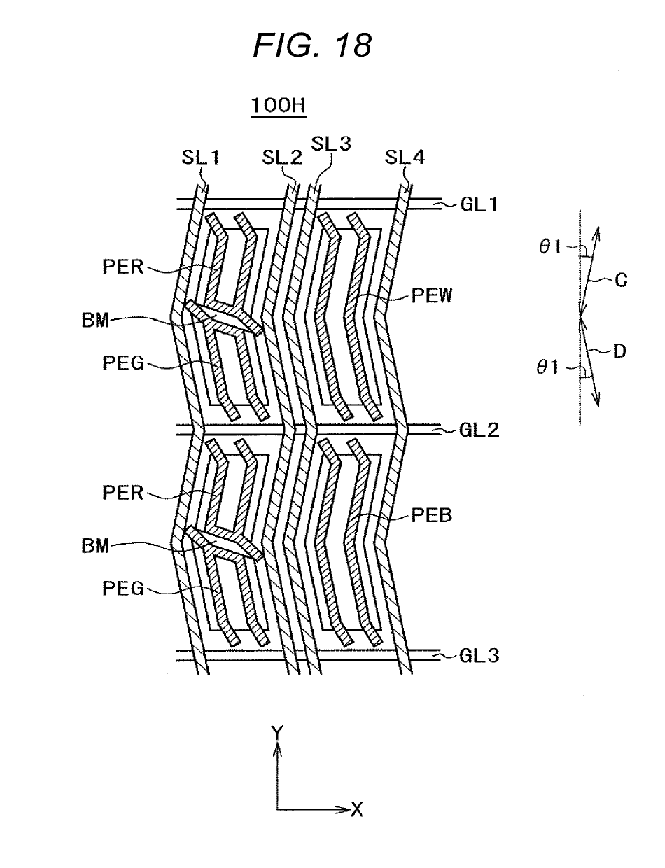

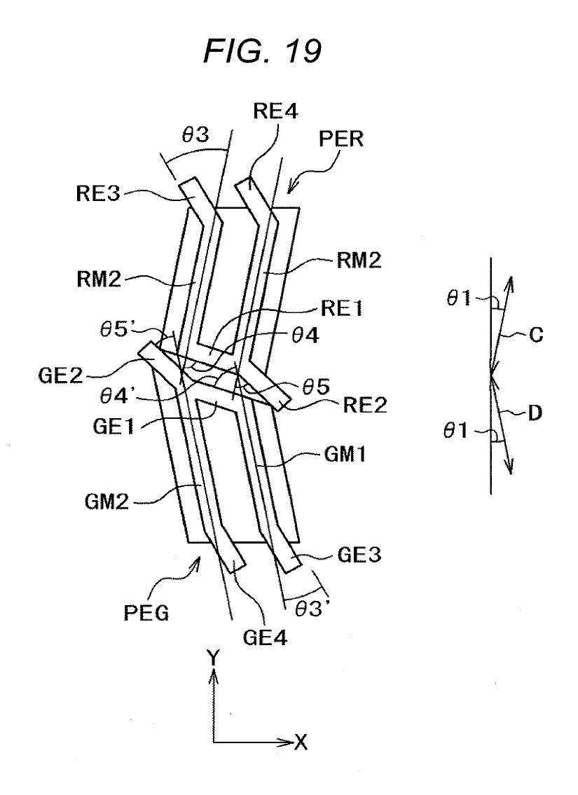

Using FIG. 18 and FIG. 19, an explanation will be made about a display device according to a first modified embodiment of the embodiment 3. FIG. 18 is a plan view showing patterns of the pixel array and pixel electrode of the display device according to the modified embodiment 3-1. FIG. 19 is a plan view showing, in detail, the pattern of the pixel electrode of the display device according to the modified embodiment 3-1.

Regarding a display device 100H according to the embodiment 3-1, arrangement of the pixels, scanning lines and the signal lines, and their connections are basically the same as those of the display device 100C. The display device 100H and the display device 100C are, however, different in configuration of each of the subpixel and the pixel electrode.

As shown in FIG. 18, configuration of the opening portion of each of the red subpixel and the green subpixel is a trapezium having two sides parallel in the direction in which the single line extends, where another first side is provided along the direction X and another second side is inclined by a predetermined angle relative to the direction X. The opening portion of each of the white subpixel and blue subpixel is bent and is a combination of an upper side which is a parallelogram inclined in the clockwise direction, in plan view, relative to the direction Y and a lower side which is a parallelogram inclined in the counterclockwise direction, in plan view, relative to the direction Y. Further, despite a roundness of each of the four corners of the opening of one of the respective subpixels, the configuration of each opening is referred to as trapezium or parallelogram. The scanning lines GL1 to G13 are provided along the direction X. The signal lines SL1 to S14 are each disposed in a manner to be bent per pixel. The signal lines SL1 to SL4 are each bent a first position in the vicinity of an intermediate position of the scanning line and a second position in which the scanning line is disposed. The direction in which the signal lines SL1 to SL4 extend has a portion parallel to the direction C, causing an inclination of θ1 in the clockwise direction relative to the direction Y. The direction in which the signal lines SL1 to SL4 extend has a portion parallel to the direction D, causing an inclination of θ1 in the counterclockwise direction relative to the direction Y.

As shown in FIG. 19, the pixel electrode PER has main electrode portions RM1, RM2 and first to fourth electrode portions RE1 to RE4. The main electrode portion RM1 and the main electrode portion RM2 are each connected with the first electrode portion RE1. The main electrode portions RM1, RM2 extend in the direction C inclined by θ1 in the clockwise direction, in plan view, relative to the direction Y. The third and fourth electrode portions RE3, RE4 are bent by θ3 in the counterclockwise direction, in plan view, relative to the direction C. θ3 is set in a range of 5° to 45°. The first electrode portion RE1 is bent by θ4 in the counterclockwise direction, in plan view, relative to the direction C. θ4 is larger than θ3 and set in a range of 20° to 75°. The second electrode portion RE2 is bent by θ5 in the counterclockwise direction, in plan view, relative to the direction C. θ5 is larger than or equal to θ3 and smaller than θ4.

The pixel electrode PEG includes the main electrode portions GM1, GM2 and the first to fourth electrode portions GE1, GE2, GE3, GE4. The main electrode portion GM1 and the main electrode portion GM2 are connected with the first electrode portion GE1. The first electrode portion GE1 opposes the first electrode portion RE1. The main electrode portions GM1, GM2 extend in the direction D inclined by θ1 in the counterclockwise direction, in plan view, relative to the direction −Y. The electrode portions GE3, GE4 are bent by θ3′ in the counterclockwise direction, in plan view, relative to the direction D. θ3′ is set in a range of 5° to 45°. The first electrode portion GE1 is bent by θ4′ in the counterclockwise direction, in plan view, relative to the direction D. θ4′ is larger than θ3′ and is set in a range of 20° to 75°. The second electrode portion GE2 is, in plan view, bent by θ5′ in the counterclockwise direction relative to the direction D. θ5′ is larger than or equal to θ3′ and is smaller than θ4′.

The light-shielding portion between the opening portion of the red subpixel and the opening portion of the green subpixel extends in a manner to be inclined by θ4−θ1 relative to the direction Y (90°−θ4+θ1 relative to the direction X). The area between the red subpixel and the green subpixel is so structured as to be divided in a direction not parallel to the direction in which the scanning line extends. Due to this, arranging the comb tooth electrode by activating the effective pixel to the maximum extent possible can suppress reduction of transmission.

Further, the main electrodes of the white and blue pixel electrodes PEW, PEB are, in plan view, parallel to the red and green main electrode portions RM1, RM2, GM1, GM2. Further, the electrodes on both ends of the white and blue pixel electrodes PEW, PEB are, in plan view, parallel to the red and green electrode portions RE3, RE4, GE3, GE4.

### Example 3-2

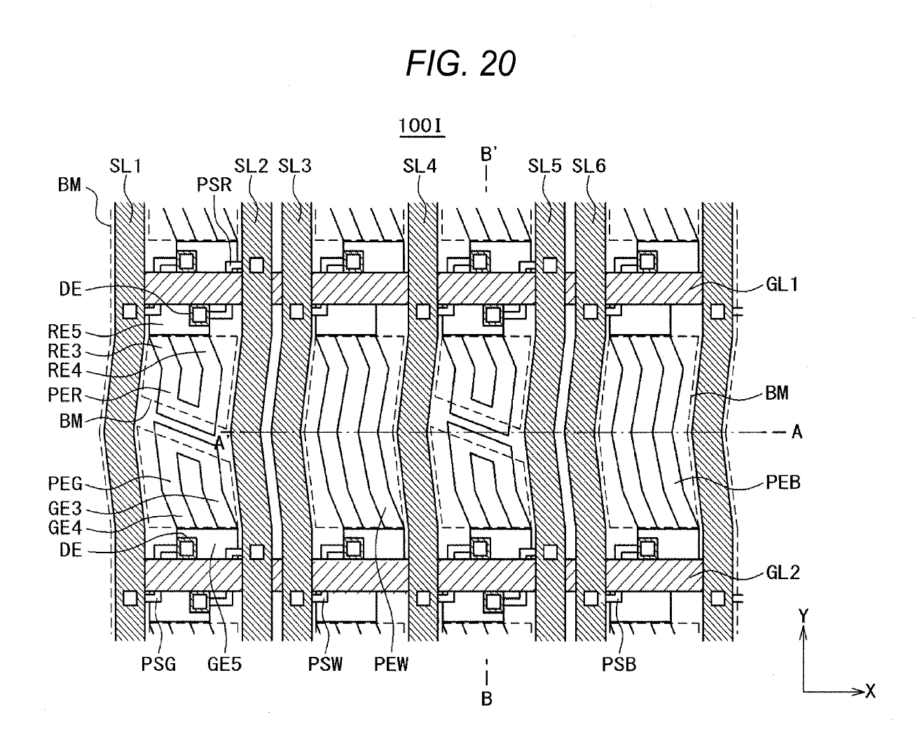

Using FIG. 20, an explanation will be made about a display device according to an example (example 3-2) of the modified embodiment 3-1. FIG. 20 is a plan view showing patterns of the scanning line, signal line, pixel electrode and light-shielding portion of the display device according to the example 3-2.

Regarding a display device 100I according to the example 3-2, arrangement of the pixels, scanning lines and signal lines, and their connections are basically the same as those of the display device 100S.

As shown in FIG. 20, the display device 100I is basically the same as the display device 100G excluding that the signal line and the pixel electrode are bent.

Although explanations have been made about respective embodiments and respective modified embodiments thereof as well as respective examples and respective modified examples thereof, such embodiments or examples can be properly combined. For example, any of the embodiment 1 and the modified embodiment 1-1 may be combined with any of the modified embodiment 3-1 and the example 3-2.

Further, the pixel electrodes PE, PEB, PEG, PER, PEW each may function as a common electrode. In this case, the common electrode CE functions as a pixel electrode.

1. A display device comprising:
a first scanning line and a second scanning line which are provided along a first direction;
a first signal line and a second signal line which are provided along a second direction; and
a first subpixel and a second subpixel each of which has a light-shielding portion and an opening portion;
wherein
the first subpixel and the second subpixel are disposed along the second direction,
the opening portion of each of the first subpixel and the second subpixel is disposed between the first scanning line and the second scanning line and between the first signal line and the second signal line,
each of the first subpixel and the second subpixel is provided with an electrode having a first main electrode portion and a first electrode portion connected with a first end of the first main electrode portion, and
the first electrode portion of the first subpixel and the first electrode portion of the second subpixel are provided at an interval along a direction free from being parallel to each of the first direction and the second direction.

2. The display device according to claim 1, wherein
each of the first subpixel and the second subpixel is provided with a second main electrode portion, and
each of the first electrode portion of the first subpixel and the first electrode portion of the second subpixel is connected to a first end of the second main electrode portion.

3. The display device according to claim 2, further comprising:
a third subpixel disposed between the first scanning line and the second scanning line and between the first signal line and the second signal line, and adjacent to the first subpixel and second subpixel in the first direction, and
wherein
the third subpixel has an opening portion larger than the opening portion of each of the first subpixel and the second subpixel.

4. The display device according to claim 2, wherein
each of the electrode of the first subpixel and the electrode of the second subpixel has a second electrode portion connected with the first electrode portion's first end on a side connected with the second main electrode portion, a third electrode portion connected with a second end of the first main electrode portion, and a fourth electrode portion connected with the second end of the second main electrode portion.

5. The display device according to claim 3, wherein
each of the electrode of the first subpixel and the electrode of the second subpixel has a second electrode portion connected with the first electrode portion's first end on a side connected with the second main electrode portion, a third electrode portion connected with a second end of the first main electrode portion, and a fourth electrode portion connected with the second end of the second main electrode portion.

6. The display device according to claim 4, wherein
a first angle formed by the first main electrode portion and the first electrode portion is larger than a second angle formed by the first main electrode portion and the third electrode portion.

7. The display device according to claim 6, wherein
a third angle formed by the second main electrode portion and the second electrode portion is smaller than the first angle.

8. The display device according to claim 7, wherein
the first main electrode portion and the second main electrode portion are along the second direction.

9. The display device according to claim 7, wherein
the first main electrode portion of the first subpixel and the first main electrode portion of the second subpixel are inclined in opposite directions, in plan view, by a predetermined angle relative to the second direction.

10. The display device according to claim 8, wherein
the first main electrode portion and second main electrode portion of the first subpixel are along at least a part of each of the first scanning line and the second scanning line.

11. The display device according to claim 9, wherein the first main electrode portion and second main electrode portion of the first subpixel are along at least a part of each of the first scanning line and the second scanning line.

12. The display device according to claim 1, further comprising: a third signal line adjacent to the second signal line and provided along the second direction,
a fourth signal line provided along the second direction, and a third subpixel or a fourth subpixel each having a light-shielding portion and an opening portion,
wherein
an interval between the second signal line and the third signal line is narrower than each of an interval between the first signal line and the second signal line and an interval between the third signal line and the fourth signal line,
the opening portion of the third subpixel and the opening portion of the fourth subpixel are each larger than the opening portion of the first subpixel and the opening portion of the second subpixel, and
the opening portion of the third subpixel or the opening portion of the fourth subpixel is disposed between the first scanning line and the second scanning line and between the third signal line and the fourth signal line.

13. The display device according to claim 1, wherein each of the opening portion of the first subpixel and the opening portion of the second subpixel is in a form of a trapezium, and
a side faced by the opening portion of the first subpixel and the opening portion of the second subpixel is along a direction free from being parallel to the first direction or the second direction.
